(19) United States
(12) Patent Application Publication
(10) Pub. No.: US 2026/0172115 A1
(43) Pub. Date: Jun. 18, 2026

(54) OPTICAL SAFETY MECHANISM FOR ROUTED OPTICAL NETWORKING LINEAR AMPLIFIER

(71) Applicant: Cisco Technology, Inc., San Jose, CA (US)

(72) Inventors: David Bianchi, Cambiago (MI) (IT); Andrea Marchio', Limido Comasco (CO) (IT)

(21) Appl. No.: 18/985,463

(22) Filed: Dec. 18, 2024

(51) Int. Cl. H04B 10/29; H04B 10/25; H04B 10/564

(52) U.S. Cl. CPC H04B 10/29; H04B 10/25; H04B 10/564

(57) ABSTRACT

A safety mechanism for a routed optical network is provided. A method includes at an optical signal amplification device including an optical amplifier that is configured to amplify an optical signal, receiving an indication that optical power generated by the optical amplifier is not being received at a downstream optical coupler/splitter that is in communication with the optical signal amplification device, and, in response to receiving the indication, causing the optical amplifier to reduce amplification of the optical signal.

### TECHNICAL FIELD

The present disclosure relates to the operations of, and a safety mechanism for, a routed optical network.

### BACKGROUND

Data Center Interconnect solutions for routed optical networking may be deployed in a non-controlled area, leading to potential safety issues. For example, some optical networking equipment may employ an erbium-doped fiber amplifier (EDFA) with both a booster and pre-amplifier for optical signal transmission and reception, respectively. The pre-amplifier, deployed in the optical receive chain in a receive-side node, may be directed towards an inner part of the node, such as towards a passive Multiplexer/Demultiplexer, widely adopted in such an application. In this type of configuration, there is a scenario in which the pre-amplifier does not shut down or reduce power in the event of a broken or severed fiber that connects the pre-amplifier to the Multiplexer/Demultiplexer, leading to the possibility of uncontained laser light in the non-controlled area, and thus the possibility of endangering users and operators.

### BRIEF DESCRIPTION OF THE DRAWINGS

FIG. 1 is a block diagram of a routed optical network including an optical signal amplification device that hosts optical power monitoring logic, according to an example embodiment.

FIG. 2 is a block diagram of a portion of the routed optical network of FIG. 1 and shows an optical power feedback connection between an optical coupler/splitter and the optical signal amplification device, according to an example embodiment.

FIG. 3 shows details of the optical signal amplification device, including optical power monitoring logic, according to an example embodiment.

FIG. 4 is a schematic diagram of an optical coupler/splitter in which an optical power feedback signal may be generated, according to an example embodiment.

FIG. 5 is a flowchart depicting a series of operations to perform optical power feedback monitoring, according to an example embodiment.

FIG. 6 is a block diagram of a computing device that may be configured to host optical power monitoring logic, and to perform techniques described herein, according to an example embodiment.

### DETAILED DESCRIPTION

### Overview

A safety mechanism for a routed optical network is provided. A method includes, at an optical signal amplification device including an optical amplifier that is configured to amplify an optical signal, receiving an indication that optical power generated by the optical amplifier is not being received at a downstream optical coupler/splitter that is in communication with the optical signal amplification device, and, in response to receiving the indication, causing the optical amplifier to reduce or cease amplification of the optical signal.

An apparatus is also presented herein that includes an interface configured to enable network communications, a memory, an optical amplifier, and one or more processors coupled to the interface, the memory, and the optical amplifier, and configured to: receive an indication that optical power of an optical signal generated by the optical amplifier is not being received at a downstream optical coupler/splitter that is in communication with the apparatus, and in response to receiving the indication, cause the optical amplifier to reduce amplification of the optical signal.

### Example Embodiments

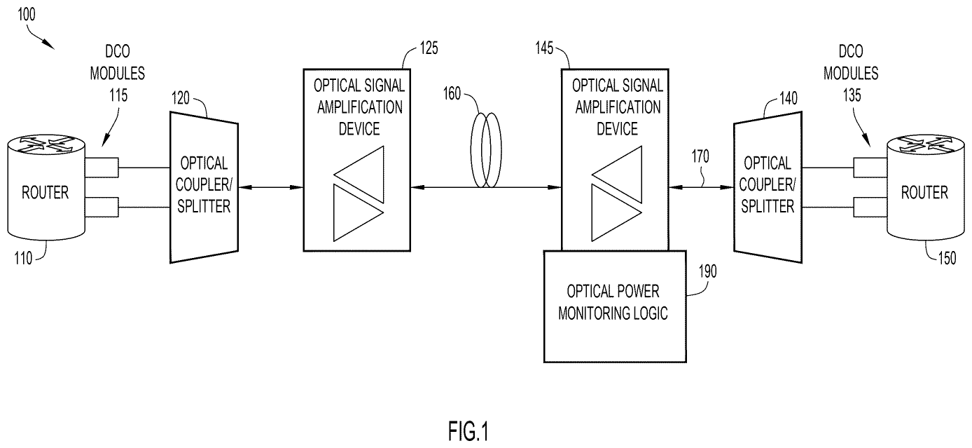

FIG. 1 is a block diagram of a routed optical network including an optical signal amplification device that hosts optical power monitoring logic, according to an example embodiment. Specifically, a routed optical network 100 includes, starting on the left side of the figure, a first router 110, a first set of digital coherent optics modules 115 (or DCO modules), a first optical coupler/splitter 120, such as a multiplexer/demultiplexer or splitter, a first optical signal amplification device 125, a second optical signal amplification device 145, a second optical coupler/splitter 140, a second set of digital coherent optics modules 135, and a second router 150. First optical signal amplification device 125 and second optical signal amplification device 145 are in communication with one another via a fiber optic cable 160.

The routed optical network 100 is a bi-directional network that enables communication to/from first router 110 and second router 150. For example, there may be data that is intended to be transmitted from first router 110 to second router 150. In such a case, the data, handled in the electrical domain by first router 110, is converted, by a given DCO module in the first set of digital coherent optics modules 115, into an optical signal. First optical coupler/splitter 120 then multiplexes, or combines, the optical signal with other optical signals from other DCO modules. The resulting combined or multiplexed optical signal is then passed to first optical signal amplification device 125, which amplifies, or boosts, the multiplexed optical signal to be transmitted via fiber optic cable 160.

On the receive side, on the right side of FIG. 1, second optical signal amplification device 145 receives the combined or multiplexed optical signal, applies pre-amplification to the combined or multiplexed optical signal, and supplies the resulting pre-amplified combined or multiplexed optical signal to second optical coupler/splitter 140, which demultiplexes or splits the pre-amplified combined or multiplexed optical signal into individual channels that are then, respectively, supplied to given DCO modules of the second set of digital coherent optics modules 135 that convert the individual channels into signals in the electrical domain to be processed by second router 150.

In the event an optical link 170, in the receive side node, between second optical signal amplification device 145 and second optical coupler/splitter 140 is broken or severed, laser light from the severed link could endanger unsuspecting users or operators, especially if the optical link 170 is in a non-controlled area and the users or operators working in that area are not trained for such a scenario. In this regard, optical power monitoring logic 190 is provided to reduce or to eliminate the risk of this potential danger. Details of the functionality of optical power monitoring logic 190 are provided below.

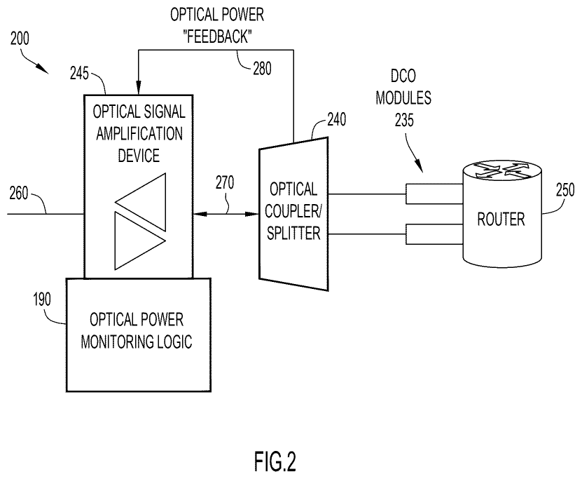

FIG. 2 is a block diagram of a portion of the routed optical network of FIG. 1 and shows an optical power feedback connection between an optical coupler/splitter 240 and an optical signal amplification device 245, according to an example embodiment. That is, FIG. 2 shows components of a receive side node 200 of a routed optical network that correspond to the components on the right-hand side of FIG. 1. Here, a fiber optic cable 260 is connected to optical signal amplification device 245. The optical signal amplification device 245 is in communication, via optical link 270, with optical coupler/splitter 240, which is in communication with a set of digital coherent optics modules 235, which convert incoming optical signals into signals in the electrical domain so that a router 250 can further process incoming data.

Also shown in FIG. 2 is an optical feedback connection 280 that supplies optical power back to optical signal amplification device 245 as long as optical power is being received at optical coupler/splitter 240 from optical signal amplification device 245, via optical link 270. In the event optical link 270 is severed, optical power is no longer fed back to optical signal amplification device 245, thus signaling optical signal amplification device 245, and specifically optical power monitoring logic 190, to reduce or to stop any pre-amplification that may be being applied to an incoming optical signal from fiber optic cable 260.

It is noted that both optical signal amplification device 245 and optical coupler/splitter 240 are often co-located in a same room or closet, but those components could also be located in separate physical areas or locations.

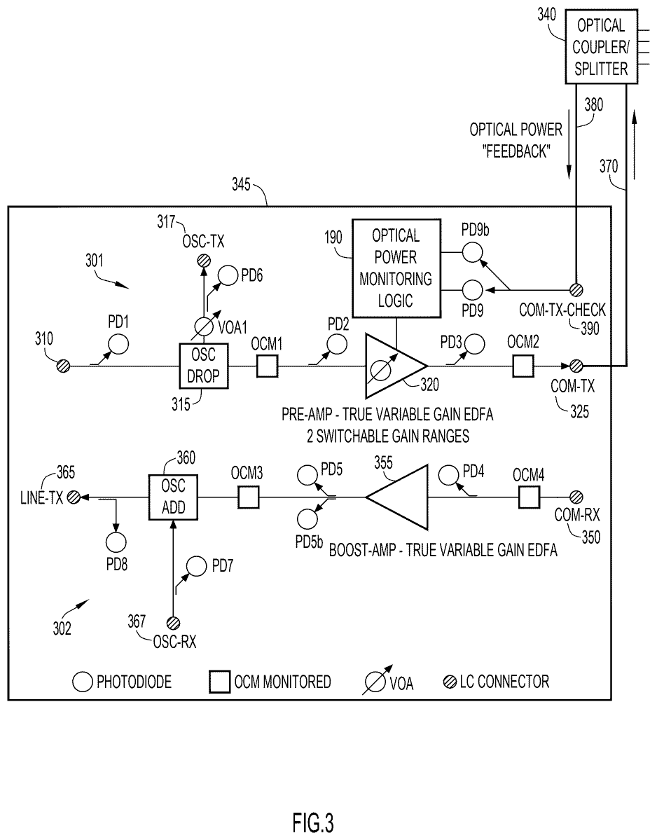

FIG. 3 shows details of an optical signal amplification device 345, such as second optical signal amplification device 145 of FIG. 1 or optical signal amplification device 245 of FIG. 2, including optical power monitoring logic 190, according to an example embodiment. Optical signal amplification device 345 may include a receive section 301 and a transmit section 302. Receive section 301 may include an input port 310 that is connected to an optical supervisory channer (OSC) drop module 315. An output of the OSC drop module 315 is connected to a pre-amplifier 320, which generates an amplified optical signal that is supplied to a COM-TX port 325, which supplies the amplified optical signal to, e.g., optical coupler/splitter 340, which is analogous to optical coupler/splitter 240 in FIG. 2. Another output of the OSC drop module 315 is passed through variable optical amplifier VOA1 to an OSC-TX port 317. Transmit section 302 includes a COM-RX input port 350 that supplies an outgoing optical signal to a boost amplifier 355. An output of the boost amplifier 355 is supplied to an OSC add module 360. An output of OSC add module 360 is supplied to a LINE-TX output port 365, which may be connected, e.g., to fiber optic cable 260 in FIG. 2. Another input to the OSC add module 360 is connected to an OSC-RX port 367. A COM-TX check port 390, in the receive section 301, is also provided.

Several photodetectors are deployed throughout the topology of optical signal amplification device 345 including PD1, PD2, PD3, PD6, PD9 and PD9b in receive section 301, and PD4, PD5, PD5b, PD7 and PD8 in transmit section 302. These photodetectors output an electrical signal indicative of the presence/intensity of optical power and thus may be used to monitor different parts or segments of optical signal amplification device 345. Several optical channel monitoring (OCM) components are provided including OCM1, OCM2, OCM3, and OCM4 as shown, but are not relevant to the operations of the described embodiments. Similarly, the OSC drop module 315 and OSC add module 360 are nor directly relevant to the operations of the described embodiments.

In accordance with an embodiment, COM-TX check port 390 is configured to receive an optical power feedback signal indicative of optical power being received and processed, e.g., by optical coupler/splitter 340. Optical coupler/splitter 340 may be a passive device, and the optical power feedback signal may be generated from the optical power that it receives. That is, an optical feedback connection 380, which is analogous to optical feedback connection 280 in FIG. 2, supplies (or does not supply) an optical power feedback signal indicative of optical power being received and processed, e.g., by optical coupler/splitter 340. This optical power feedback signal may be detected by photodetector PD9 and/or PD9b. If no optical power is detected from optical feedback connection 380, this suggests that no optical power is reaching optical coupler/splitter 240 via optical link 370, which is analogous to optical link 270 in FIG. 2, and thus further suggests that optical link 370 (or optical link 270) may be damaged or severed.

Optical power monitoring logic 190 is configured to monitor the output of photodetector PD9 and/or PD9b and, when no optical power feedback signal is detected, to cause pre-amplifier 320 to reduce pre-amplification, or to cease its pre-amplification function, thereby reducing or eliminating optical power from emanating from a broken or severed optical cable, namely, optical link 370.

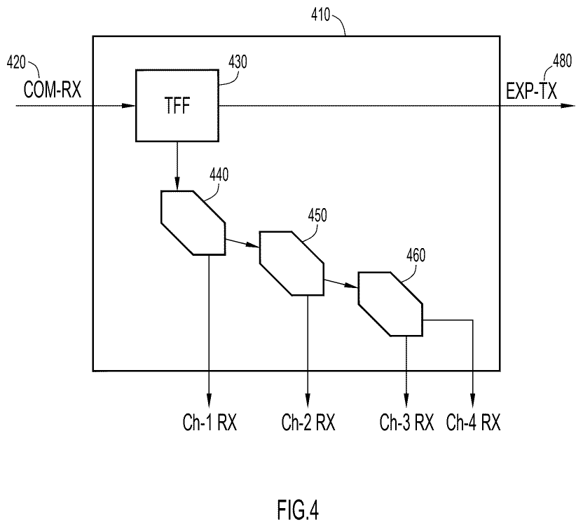

FIG. 4 is a schematic diagram of an optical coupler/splitter 410 in which the optical power feedback signal may be generated, according to an example embodiment. In this case, optical coupler/splitter 410 is configured as a passive demultiplexer and includes a COM-RX port 420 that is configured to receive a pre-amplified optical signal from, e.g., COM-TX port 325. The received optical signal is then demultiplexed, or split, into four respective optical channels, Ch-1 RX, Ch-2 RX, Ch-3 RX, Ch-4 RX, via, e.g., a series of thin film filters (TFFs) 430, 440, 450, 460. Optical power associated with the respective channels may be supplied to respective DCO modules that are connected to a downstream router, such as router 250 in FIG. 2.

Notably, not all optical power received at COM-RX port 420 is fully directed for channel demultiplexing. There is typically some amount of “spillover” optical power or “residual” optical power that is not directed to, e.g., TFF 440. That spillover or residual optical power is directed to (express) EXP-TX port 480, and, in accordance with an embodiment, the spillover or residual optical power is used as the optical power feedback signal that is fed back to optical signal amplification device 345 via, e.g., the COM-TX check port 390, which is monitored by optical power monitoring logic 190 via photodetector PD9/PD9b.

In other words, a pre-amplified optical signal is transmitted from optical signal amplification device 345 to optical coupler/splitter 340 and some of the optical power from the pre-amplified optical signal passes through the optical coupler/splitter 340 and is fed back to the optical signal amplification device 345. As long as optical power monitoring logic 190 detects power at the COM-TX check port 390 no action is performed. On the other hand, when no optical power is detected at the COM-TX check port 390, and pre-amplifier 320 is operational and amplifying an incoming optical signal, this suggests that the amplified optical signal from optical signal amplification device 345 is not reaching optical coupler/splitter 340 in the first place. This could mean that optical link 270, or optical link 370, is broken, or severed, possibly leading to a dangerous safety issue, especially in a non-controlled area. To address such a safety issue, optical power monitoring logic 190 is configured to control pre-amplifier 320 to reduce a level of amplification, including stopping or ceasing its amplification altogether. This could be accomplished via an enable/disable signal supplied from optical power monitoring logic 190 to pre-amplifier 320, or by sending a predetermined control/gain signal to pre-amplifier 320.

Referring still to FIG. 4, it is noted that instead of using the spillover or residual power passed to the EXP-TX port 480, one of the split-off optical channels, Ch-1 RX, Ch-2 RX, Ch-3 RX, Ch-4 RX, could be fed back as the optical power feedback signal via optical feedback connection 380. Of course, such an implementation would reduce the number of available data channels.

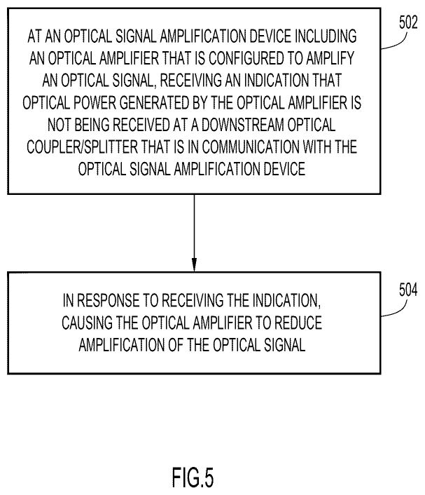

FIG. 5 is a flowchart depicting a series of operations perform optical power feedback monitoring, according to an example embodiment. At 502, an operation includes, at an optical signal amplification device including an optical amplifier that is configured to amplify an optical signal, receiving an indication that optical power generated by the optical amplifier is not being received at a downstream optical coupler/splitter that is in communication with the optical signal amplification device. And, at 504, an operation includes, in response to receiving the indication, causing the optical amplifier to reduce amplification of the optical signal. It is noted that “reduction” of the amplification could also include ceasing, shutting down, or turning off, the amplification.

It is also noted that in some embodiments, and in connection with restart of the system after repair of a broken or severed optical link 170 or optical link 270, optical power monitoring logic 190 may also be used to ensure that there is continuity between optical signal amplification device 245 and optical coupler/splitter 240. Optical signal amplification device 245 may remain in an automatic power reduction (APR) mode until such continuity is confirmed.

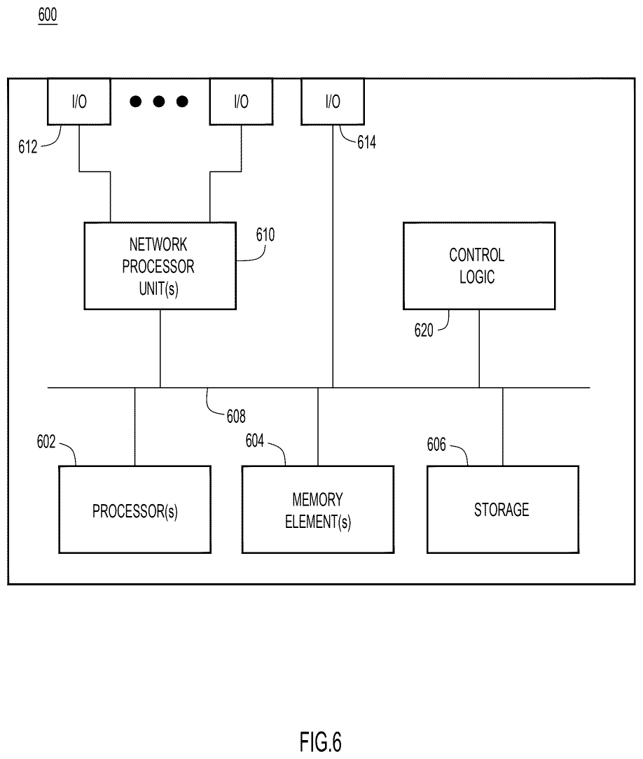

FIG. 6 is a block diagram of a computing device that may be configured to host optical power monitoring logic, and to perform techniques described herein, according to an example embodiment. In various embodiments, a computing device, such as computing device 600 or any combination of computing devices 600, may be configured as any entity/entities as discussed for the techniques depicted in connection with FIGS. 1-5 in order to perform operations of the various techniques discussed herein. The computing device 600 could be implemented with dedicated hardware.

In at least one embodiment, the computing device 600 may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa) or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include, at an optical signal amplification device including an optical amplifier that is configured to amplify an optical signal, receiving an indication that optical power generated by the optical amplifier is not being received at a downstream optical coupler/splitter that is in communication with the optical signal amplification device; and in response to receiving the indication, causing the optical amplifier to reduce amplification of the optical signal.

The method may further include receiving the indication via a fiber optic cable at the optical signal amplification device.

In the method, the downstream optical coupler/splitter may include an optical demultiplexer, and the indication may be representative of residual optical power remaining after the optical signal is demultiplexed by the optical demultiplexer.

In the method, the downstream optical coupler/splitter may be an optical splitter.

In the method, the downstream optical coupler/splitter may be a passive optical device.

The method may further include receiving the indication at a communications check port of the optical signal amplification device.

The method may further include monitoring an output of a photodetector associated with the communications check port, and, when no signal is detected at the photodetector, causing the optical amplifier to reduce amplification of the optical signal.

In the method, the optical signal amplification device and the downstream optical coupler/splitter may be co-located.

In the method, causing the optical amplifier to reduce amplification of the optical signal includes causing the optical amplifier to cease amplifying the optical signal.

In the method, the optical signal amplification device and the downstream optical coupler/splitter may be part of a routed optical network.

In another embodiment, an apparatus may be provided and may include an interface configured to enable network communications, a memory, an optical amplifier, and one or more processors coupled to the interface, the memory, and the optical amplifier, and configured to: receive an indication that optical power of an optical signal generated by the optical amplifier is not being received at a downstream optical coupler/splitter that is in communication with the apparatus, and in response to receiving the indication, cause the optical amplifier to reduce amplification of the optical signal.

In the apparatus, the one or more processors may be further configured to receive the indication via a fiber optic cable.

In the apparatus, the downstream optical coupler/splitter may include an optical demultiplexer, and the indication may be representative of residual optical power remaining after the optical signal is demultiplexed by the optical demultiplexer.

In the apparatus, the downstream optical coupler/splitter may be an optical splitter.

In the apparatus, the downstream optical coupler/splitter may be a passive optical device.

In the apparatus, the one or more processors may be further configured to receive the indication at a communications check port of the apparatus.

In the apparatus, the one or more processors may be further configured to monitor an output of a photodetector associated with the communications check port, and, when no signal is detected at the photodetector, cause the optical amplifier to reduce amplification of the optical signal.

In yet another embodiment, one or more non-transitory computer readable storage media encoded with instructions are provided and that, when executed by a processor, cause the processor to: at an optical signal amplification device including an optical amplifier that is configured to amplify an optical signal, receive an indication that optical power generated by the optical amplifier is not being received at a downstream optical coupler/splitter that is in communication with the optical signal amplification device, and in response to receiving the indication, cause the optical amplifier to reduce amplification of the optical signal.

The instructions may be further configured to receive the indication via a fiber optic cable at the optical signal amplification device.

In this embodiment, the downstream optical coupler/splitter may be an optical demultiplexer, and the indication may be representative of residual optical power remaining after the optical signal is demultiplexed by the optical demultiplexer.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
at an optical signal amplification device including an optical amplifier that is configured to amplify an optical signal, receiving an indication that optical power generated by the optical amplifier is not being received at a downstream optical coupler/splitter that is in communication with the optical signal amplification device; and
in response to receiving the indication, causing the optical amplifier to reduce amplification of the optical signal.

2. The method of claim 1, further comprising receiving the indication via a fiber optic cable at the optical signal amplification device.

3. The method of claim 1, wherein the downstream optical coupler/splitter comprises an optical demultiplexer, and the indication is representative of residual optical power remaining after the optical signal is demultiplexed by the optical demultiplexer.

4. The method of claim 1, wherein the downstream optical coupler/splitter is an optical splitter.

5. The method of claim 1, wherein the downstream optical coupler/splitter is a passive optical device.

6. The method of claim 1, further comprising receiving the indication at a communications check port of the optical signal amplification device.

7. The method of claim 6, further comprising monitoring an output of a photodetector associated with the communications check port, and, when no signal is detected at the photodetector, causing the optical amplifier to reduce amplification of the optical signal.

8. The method of claim 1, wherein the optical signal amplification device and the downstream optical coupler/splitter are co-located.

9. The method of claim 1, wherein causing the optical amplifier to reduce amplification of the optical signal comprises causing the optical amplifier to cease amplifying the optical signal.

10. The method of claim 1, wherein the optical signal amplification device and the downstream optical coupler/splitter are part of a routed optical network.

11. An apparatus comprising:
an interface configured to enable network communications;
a memory;
an optical amplifier; and
one or more processors coupled to the interface, the memory, and the optical amplifier, and configured to:
receive an indication that optical power of an optical signal generated by the optical amplifier is not being received at a downstream optical coupler/splitter that is in communication with the apparatus; and
in response to receiving the indication, cause the optical amplifier to reduce amplification of the optical signal.

12. The apparatus of claim 11, wherein the one or more processors are further configured to receive the indication via a fiber optic cable.

13. The apparatus of claim 11, wherein the downstream optical coupler/splitter comprises an optical demultiplexer, and the indication is representative of residual optical power remaining after the optical signal is demultiplexed by the optical demultiplexer.

14. The apparatus of claim 11, wherein the downstream optical coupler/splitter is an optical splitter.

15. The apparatus of claim 11, wherein the downstream optical coupler/splitter is a passive optical device.

16. The apparatus of claim 11, wherein the one or more processors are further configured to receive the indication at a communications check port of the apparatus.

17. The apparatus of claim 16, wherein the one or more processors are further configured to monitor an output of a photodetector associated with the communications check port, and, when no signal is detected at the photodetector, cause the optical amplifier to reduce amplification of the optical signal.

18. One or more non-transitory computer readable storage media encoded with instructions that, when executed by a processor, cause the processor to:
at an optical signal amplification device including an optical amplifier that is configured to amplify an optical signal, receive an indication that optical power generated by the optical amplifier is not being received at a downstream optical coupler/splitter that is in communication with the optical signal amplification device; and
in response to receiving the indication, cause the optical amplifier to reduce amplification of the optical signal.

19. The one or more non-transitory computer readable storage media of claim 18, wherein the instructions are configured to receive the indication via a fiber optic cable at the optical signal amplification device.

20. The one or more non-transitory computer readable storage media of claim 18, wherein the downstream optical coupler/splitter comprises an optical demultiplexer, and the indication is representative of residual optical power remaining after the optical signal is demultiplexed by the optical demultiplexer.
